(19) United States
(12) Patent Application Publication
(10) Pub. No.: US 2008/0049936 A1
(43) Pub. Date: Feb. 28, 2008

(54) Optical Disc Signal Processing Circuit

(75) Inventors: Takeshi Naganuma, Gifu (JP); Miyuki Okamoto, Gifu (JP); Hidemitsu Senoo, Osaka (JP)

Correspondence Address: FISH & RICHARDSON P.C., P.O. BOX 1022, MINNEAPOLIS, MN, 55440-1022, US

(73) Assignees: SANYO ELECTRIC CO., LTD., Osaka (JP); SANYO SEMICONDUCTOR CO., LTD., Gunma (JP)

(21) Appl. No.: 11/832,462

(22) Filed: Aug. 1, 2007

(30) Foreign Application Priority Data
Aug. 10, 2006 (JP) 2006-217982

(51) Int. Cl. H04N 7/167; G06F 11/00

(52) U.S. Cl. 380/210; 714/752; 714/E11.017

(57) ABSTRACT

An optical disc signal processing circuit that includes a read data input unit configured to write read data into a buffer memory, the read data being subjected to a scramble process; an error correction processing unit configured to apply an error correction process to the read data read from the buffer memory, the error correction process being a process of performing error correction with an error correction code, and to write into the buffer memory the read data subjected to the error correction process; an external device interface unit configured to read from the buffer memory the read data subjected to the error correction process and apply a descramble process thereto; and a memory copy processing unit configured to read from the buffer memory the read data and apply the descramble process thereto, and to write into the buffer memory the read data subjected to the descramble process.

### CROSS-REFERENCE TO RELATED APPLICATION

This application claims the benefit of priority to Japanese Patent Application No. 2006-217982, filed Aug. 10, 2006, of which full contents are incorporated herein by reference.

### BACKGROUND OF THE INVENTION

1. Field of the Invention

The present invention relates to an optical disc signal processing circuit.

2. Description of the Related Art

A disc format of DVD (Digital Versatile Disc) will be described with reference to FIG. 14. In the DVD disc format, a lead-in area 20a and a lead-out area 20b are disposed on a disc inner circumference portion and a disc outer circumference portion, respectively, and a user data area 20c is disposed for recording desired information such as video and music between the above two areas. For example, in the case of DVD-R/RW, the lead-in area 20a is disposed with: RMA (Recording Management Area) indicating a recording status in the data area and having recorded thereon the record management information necessary for record reproduction; in addition to PCA (Power Calibration Area) for adjusting laser beam intensity. This record management information corresponds to, for example, a portion of TOC (Table of Contents) information recorded in PMA in the case of the CD mode and is information necessary for disc compatibility and drive control. The lead-out area 20b records final LBA (Logical Block Addressing) indicating that the user data area 20c has ended, etc.

A data format of DVD will be described with reference to FIGS. 9 to 11.

FIG. 9 is a conceptual diagram for explaining data sectors of DVD. Write data are divided into a plurality of pieces of 2048-byte data. The divided 2048-byte data are referred to as main data and a 12-byte header is added to the beginning thereof. This header includes a four-byte ID (Identification Code), a two-byte error detection code for the ID (IED: Id Error Detection Code), and a six-byte reserved data (CPM, Copyright Management Code) such as copy protection information. A four-byte EDC (Error Detection Code) is added to the end of the main data. This EDC is an error detection code for the main data with the header added.

Data with a total of 2064 bytes obtained by adding the header and EDC to the main data are handled as data sectors with 172 bytes (columns)×12 rows, which are partitioned by every 172 bytes. A scramble process is performed to randomize the 2048-byte main data among the data sectors. This scramble process is executed, for example, by generating an M sequence (random sequence) with using the ID information included in the header as an initial value (seed) and adding the generated M sequence to the main data.

FIG. 10 is a conceptual diagram for explaining a 1ECC block of DVD. The 16 data sectors are bundled to form a 172-byte×192-row matrix (hereinafter referred to as data sector group). To this data sector group, outer code parity PO and inner code parity PI are generated and added, which are an error correction code for each column and an error correction code for each row, respectively. The outer code parity PO and inner code parity PI are generated by executing a predetermined calculation process for the 2048-byte main data after the scramble process.

The 182-byte (columns)×208-row data added with the outer code parity PO and inner code parity PI, are referred to as the 1ECC block, which is handled as a unit in performing the error correction process. As shown in FIG. 11, the rows of the 1ECC block are sorted such that each of 16 rows of the outer code parity PO is sequentially positioned after each data sector with the inner code parity PI added. The 182-byte×13-row data obtained by adding the 10-byte inner code parity PI and the one-row outer code parity PO are handled as a record sector. Recoding to a DVD medium is performed after the data of the 1ECC block configured with 16 record sectors are subjected to EFM+ modulation, NRZI conversion, etc.

For the DVD medium with the data format defined as above, an optical disc signal processing circuit 10 generally executes the following recording/reproducing process with a system configuration shown in FIG. 12.

In the case of recording onto an optical disc 20, write data are received through a host I/F (host interface) unit 11 from a host computer 30 such as a personal computer and are temporarily written into a buffer memory 15 through a memory I/F (memory interface) unit 12. The write data written into the buffer memory 15 are read out through the memory I/F unit 12 to an ECC/EDC/SCR processing unit 13, are subjected to the scramble process, and are written into the buffer memory 15 again after the encoding to the 1ECC block, addition of EDC, etc. After the write data written into the buffer memory 15 are read out through the memory I/F unit 12 to a modulating/demodulating unit 14 and modulated, the write data are recorded onto the optical disc 20 by an optical pickup.

On the other hand, in the case of reproducing from the optical disc 20, the flow of the above recording case is reversed. That is, the read data read by the optical pickup from the optical disc 20 are demodulated by the modulating/demodulating unit 14 and are temporarily written into the buffer memory 15 through the memory I/F unit 12. The read data written into the buffer memory 15 are read out through the memory I/F unit 12 to the ECC/EDC/SCR processing unit 13, are subjected to the decoding process of the 1ECC block, the error correction process, and the error detection process, and are written into the buffer memory 15 again. The read data written into the buffer memory 15 are read out through the memory I/F unit 12 to the host I/F unit 11 and are transmitted to the host computer 30.

In the case of the optical disc signal process shown in FIG. 12, for example, when the recording is performed, since the writing/reading into/from the buffer memory 15 is executed for each process such as the reception of the write data from the host computer30, the encoding process of the 1ECC block by generation and addition of the ECC or EDC, and the scramble process, the number of accesses to the buffer memory 15 becomes very large and the time required for the recording process is prolonged, which makes difficult to respond to requirement of speedup of data transfer on the side of the host computer 30. The same applies to the reproducing process.

Focusing on relatively long time required for a descramble process, an arrangement has been proposed to execute the descramble process concurrently with the data transfer between the host computer 30 and the optical disc signal processing circuit 10 in order to shorten the total time required for the recording/reproducing process of the optical disc signal processing circuit 10 (see, e.g., FIG. 12 of Japanese Patent Application Laid-Open Publication No. 2001-266509). That is, the descramble process is concurrently performed when the read data are read from the buffer memory 15 and are transmitted to the host computer 30 in the process flow as shown in FIG. 13. By employing the above process flow, the number of accesses to the buffer memory 15 is reduced and the total time required for the reproducing process is shortened. When the optical disc signal processing circuit 10 employs only the arrangement of concurrently executing the descramble process at the time of the data transfer to the host computer 30, the following negative effects occur.

The data (hereinafter referred to as “disc management data”) such as the record management information and the final LBA to be recorded in the lead-in area 20a and the lead-out area 20b are managed by firmware of a microcomputer 16 that generally controls the entire system.

If the reproducing process flow shown in FIG. 13 is employed, for example, the disc management data are read from the lead-in area 20a and the lead-out area 20b and are written into the buffer memory 15 when determining the optical disc 20, and the microcomputer 16 checks the disc management data written into the buffer memory 15, the descramble process not being executed since the disc management data are not transmitted to the host computer 30. As a result, microcomputer 16 checks the disc management data in a scrambled state so that it may be disadvantageously difficult to check the data.

In the DVD-RAM standard, it is defined that standard data corresponding to a non-recording area are transmitted to the host computer 16 when reading a non-recording area. Although such standard data are defined as data configured entirely with zeros in the DVD-RAM standard and can be generated by the microcomputer 16, the data are not scrambled in this case. Therefore, if nothing is changed for the arrangement of executing the descramble process at the time of transmitting the read data to the host computer 16 as previously described, there may occur a disadvantage that the descramble process is applied to the non-scrambled standard data.

If the optical disc signal processing circuit 10 only employs the arrangement of executing the scramble process or the descramble process concurrently with the data transfer to the host computer 30, various disadvantages may be generated as described above and it is problematic that the practical use thereof is very difficult.

### SUMMARY OF THE INVENTION

An optical disc signal processing circuit according to an aspect of the present invention, comprises: a read data input unit configured to write read data into a buffer memory, the read data being read from an optical disc and subjected to a scramble process; an error correction processing unit configured to apply an error correction process to the read data read from the buffer memory, the error correction process being a process of performing error correction with an error correction code, and to write into the buffer memory the read data subjected to the error correction process; an external device interface unit configured to read from the buffer memory the read data subjected to the error correction process and apply a descramble process thereto, and to transmit to an external device the read data subjected to the descramble process; and a memory copy processing unit configured to read from the buffer memory the read data and apply the descramble process thereto, and to write into the buffer memory the read data subjected to the descramble process.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram of an overall configuration of an optical disc system according to one embodiment of the present invention;

FIG. 2 is a diagram of a configuration of a digital signal processing circuit according to one embodiment of the present invention;

FIG. 3 is a diagram of a configuration of a memory-copy/memory-fill processing unit according to one embodiment of the present invention;

FIG. 4 is a diagram for explaining operation of scramble memory copy according to one embodiment of the present invention;

FIG. 5 is a diagram for explaining operation of the scramble memory copy according to one embodiment of the present invention;

FIG. 6 is a diagram for explaining operation of descramble memory copy according to one embodiment of the present invention;

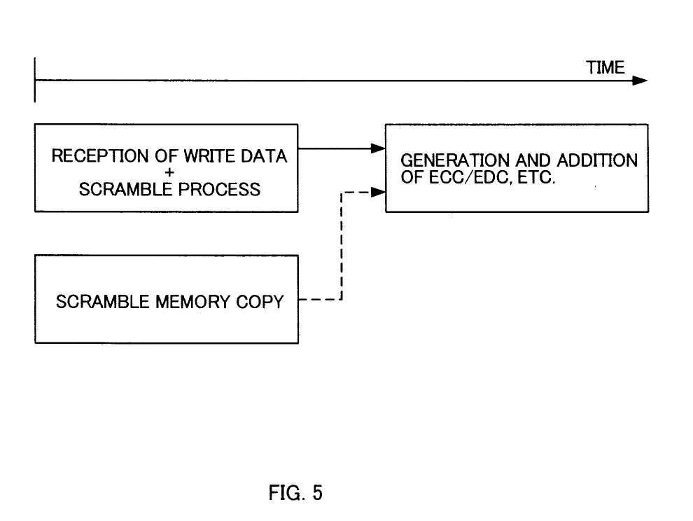

FIG. 5 is a diagram for explaining operation of the descramble memory copy according to one embodiment of the present invention;

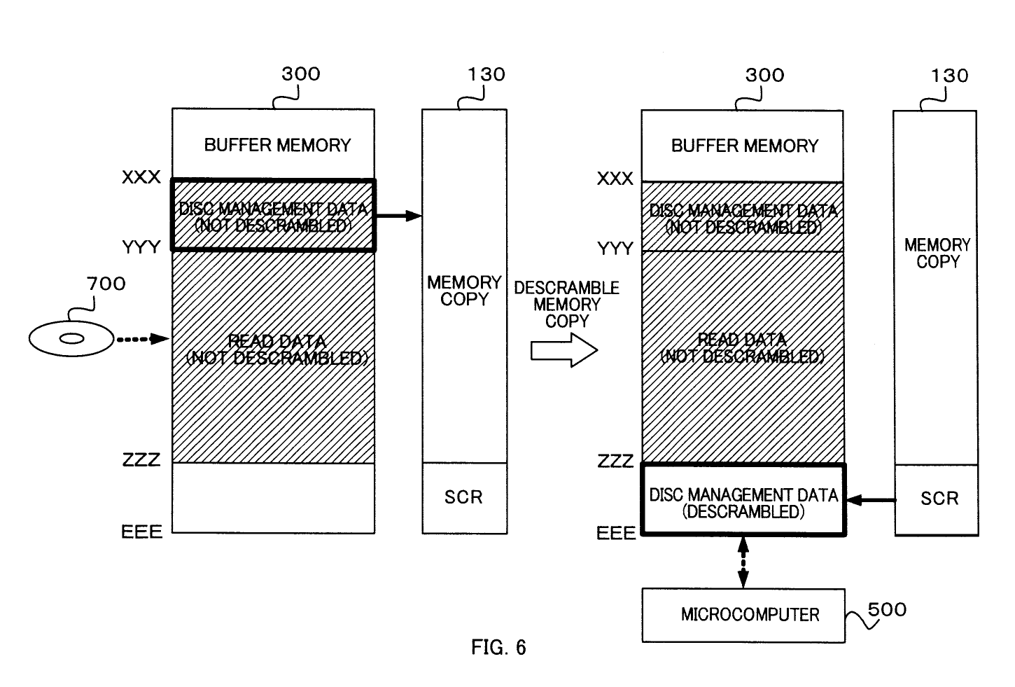

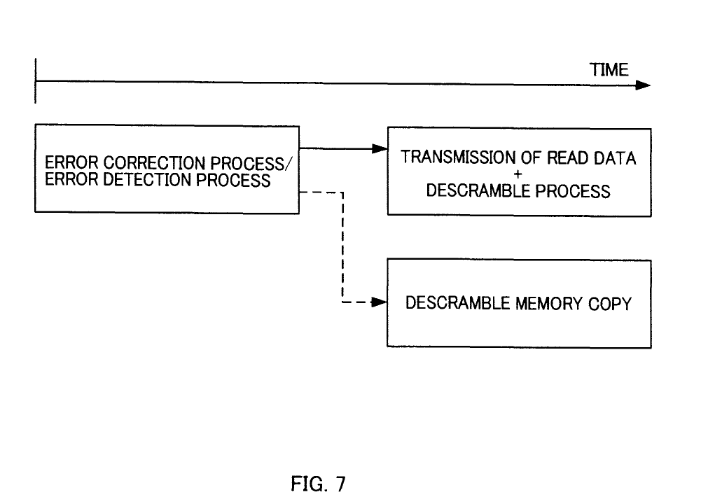

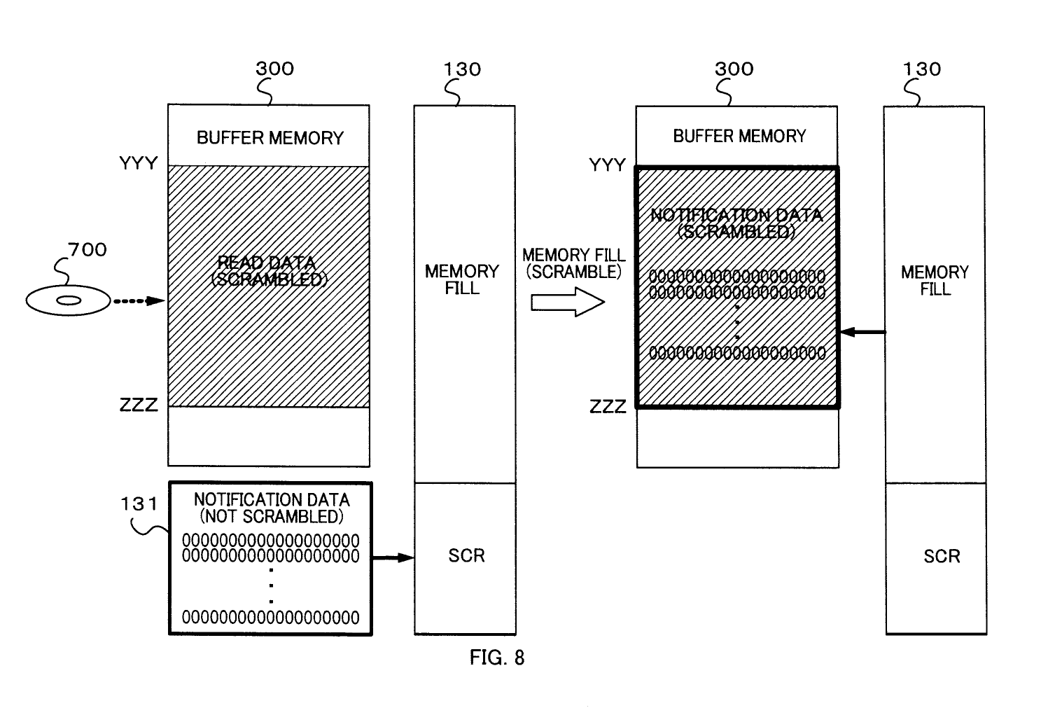

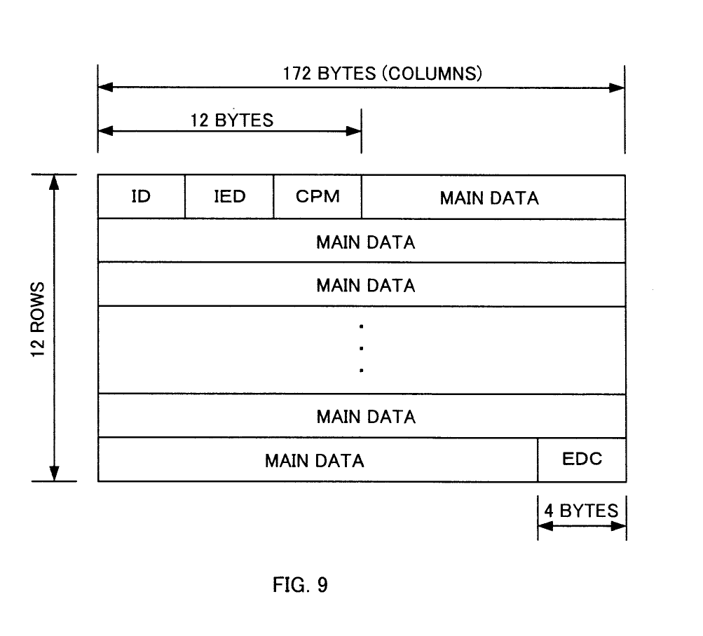

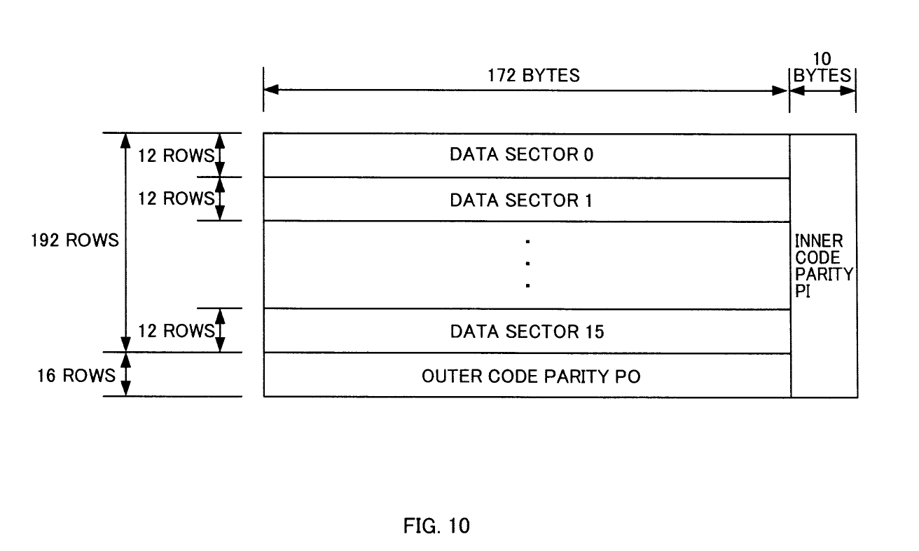

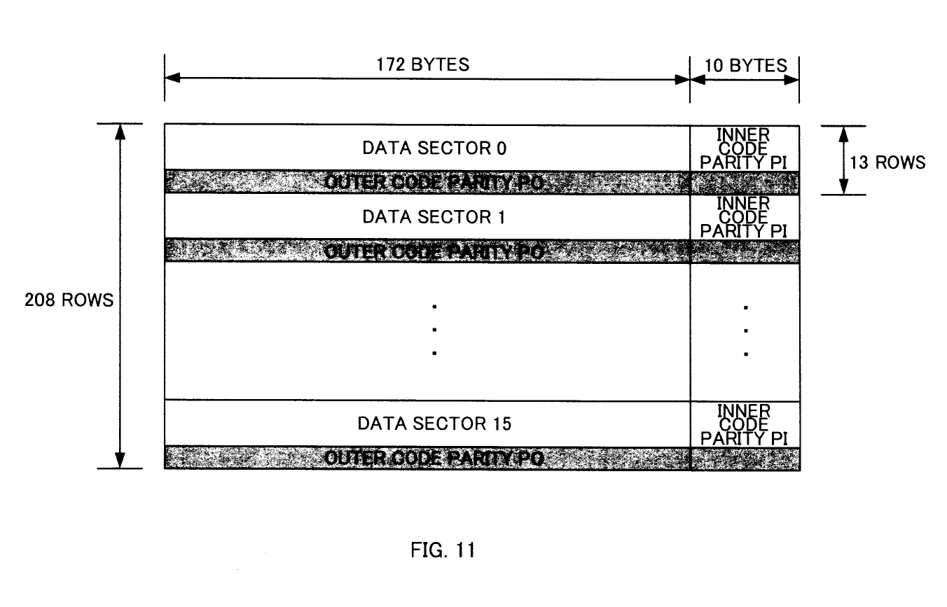

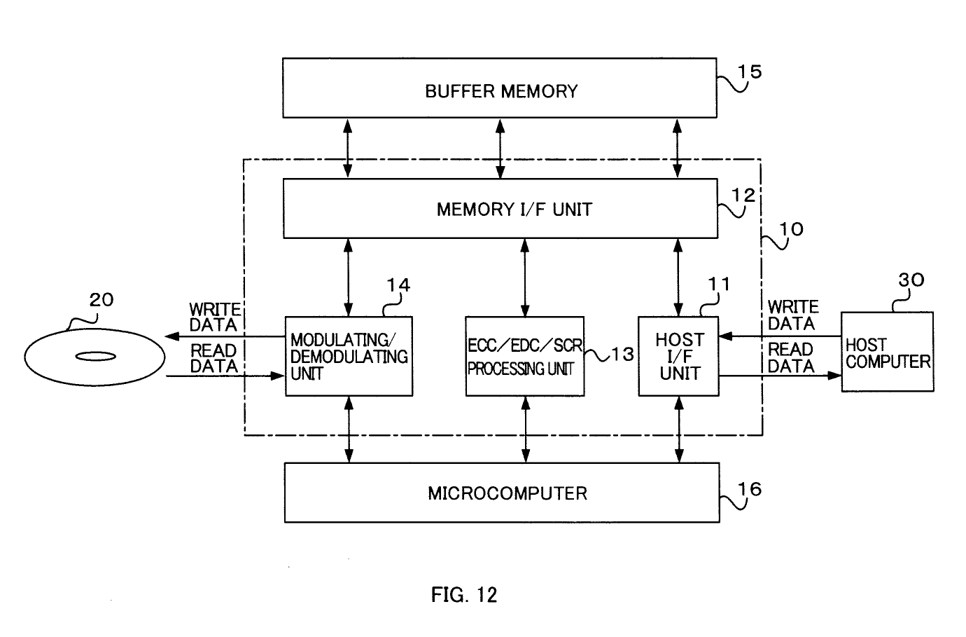

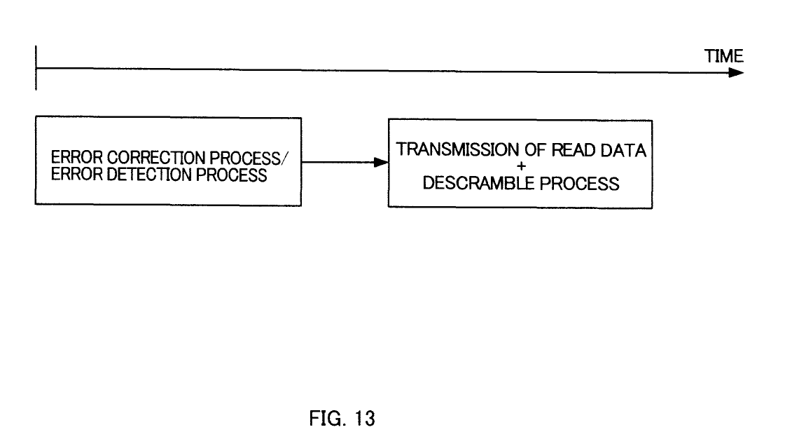

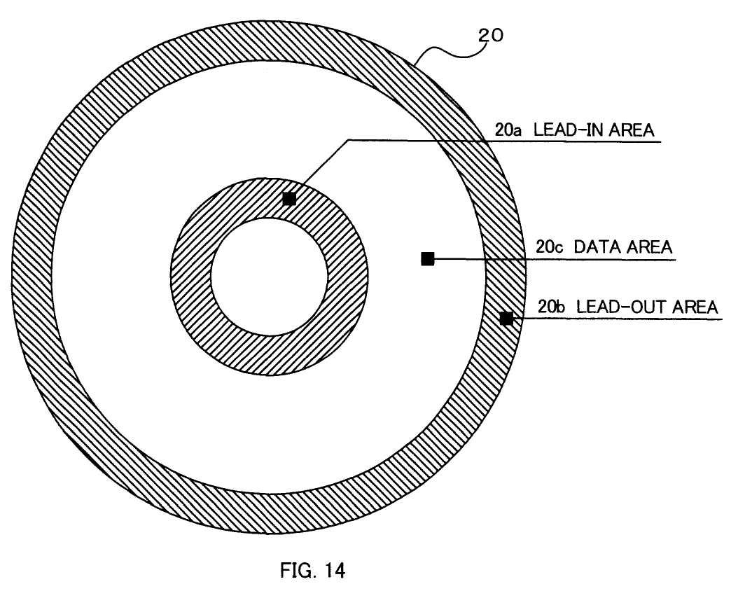

FIG. 6 is a diagram for explaining operation of memory fill according to one embodiment of the present invention;

FIG. 9 is a diagram for explaining a data sector of DVD;

FIG. 10 is a diagram for explaining an ECC block of DVD;

FIG. 11 is a diagram for explaining a record sector of DVD;

FIG. 12 is a diagram of a configuration of a conventional optical disc system;

FIG. 13 is a diagram for explaining a reproducing process of a conventional optical disc signal processing circuit; and

FIG. 14 is a diagram for explaining a disc format of DVD.

### DETAILED DESCRIPTION OF THE INVENTION

At least the following details will become apparent from descriptions of this specification and of the accompanying drawings.

<Overall Configuration of Optical Disc System>

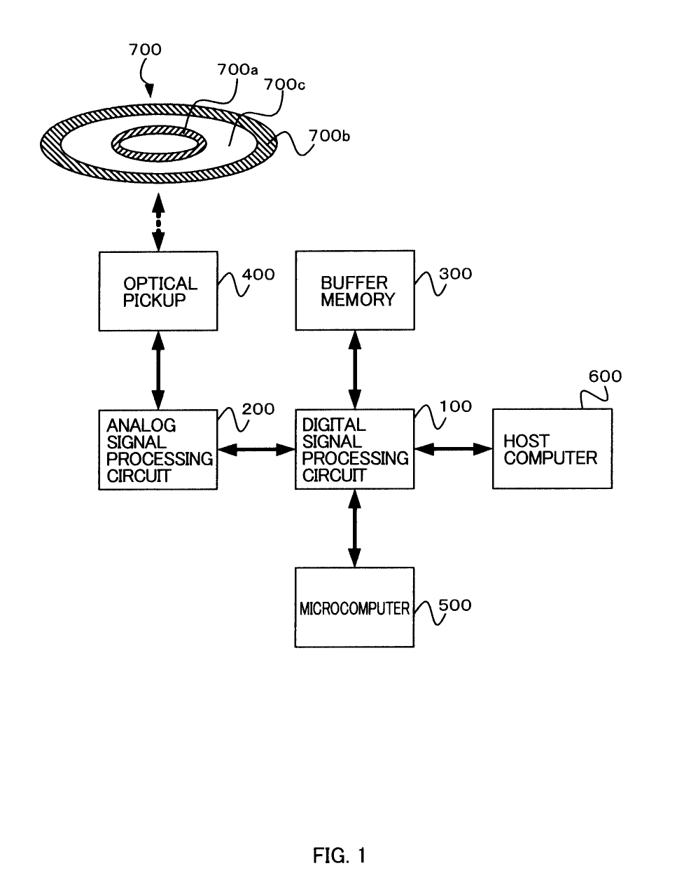

FIG. 1 is a diagram of an overall configuration of an optical disc system according to one embodiment of the present invention. The optical disc system according to an embodiment of the present invention is mainly configured with a digital signal processing circuit 100, an analog signal processing circuit 200, a buffer memory 300, an optical pickup 400, a microcomputer 500, and a host computer 600. Although the optical disc signal processing circuit according to an embodiment of the present invention is solely defined as the digital signal processing circuit 100, the optical disc signal processing circuit maybe an analog/digital mixed LSI integrated along with the analog signal processing circuit 200.

An optical disc 700 according to an embodiment of the present invention is defined as a DVD medium such as DVD±R/RW and DVD-RAM. A lead-in area 700a, a lead-out area 700b, and a user data area 700c are disposed as is the case with the disc format shown in FIG. 14. That is, the lead-in area 700a is disposed with: RMA having the record management information recorded thereon; in addition to PCA for adjusting laser beam intensity. In the lead-out area 700b, there is recorded final LBA indicating that a user data area 700c ends.

In the following description, data such as the record management information and the final LBA to be recorded in the lead-in area 700a and the lead-out area 700b are referred to as “disc management data”. The disc management data are information managed by firmware of the microcomputer 500 for each disc type of the optical disc 700. Although the disc management data are stored in the buffer memory 300 and managed by the microcomputer 500 in this embodiment, the disc management data may be stored in a memory accessible from the microcomputer 500, other than the buffer memory 300.

The digital signal processing circuit 100 includes a digital servo unit that digitally controls tracking servo, focus servo, etc., and a signal processing unit that executes a digital signal process related to recording/reproduction. The digital signal process related to recording includes processes such as a process of receiving write data from the host computer, a scramble process, a process of generating a header or EDC, an encoding process for the 1ECC block, and an EFM+ modulating process. The digital signal process related to reproduction includes an EFM+ demodulating process, an error correction process, an error detection process, a descramble process, a process of transmitting read data to the host computer, etc.

The analog signal processing circuit 200 executes an analog signal process such as drive control of a semiconductor laser (not shown) in the optical pickup 400.

The buffer memory 300 is a working memory used when the digital signal processing circuit 100 executes the digital signal process related to recording/reproduction. For example, SDRAM, etc., suitable for high integration and mass storage can be employed as the buffer memory 300.

The optical pickup 400 includes a semiconductor laser, a photodetector, an optical lens, a servo actuator, etc., (all not shown) and is driven and controlled by the analog signal processing circuit 200 to emit a laser beam for recording/reproducing into/from the optical disc 700.

The microcomputer 500 is a system controller responsible for control of the entire disc system such as the digital signal processing circuit 100, the analog signal processing circuit 200, and the optical pickup 400.

The host computer 600 is an external device such as a personal computer disposed with a DVD drive and transmits the write data to the digital signal processing circuit 100 to record the data into the optical disc 700, or receives from the digital signal processing circuit 100 the read data read and reproduced from the optical disc 700.

<Configuration of Digital Signal Processing Circuit>

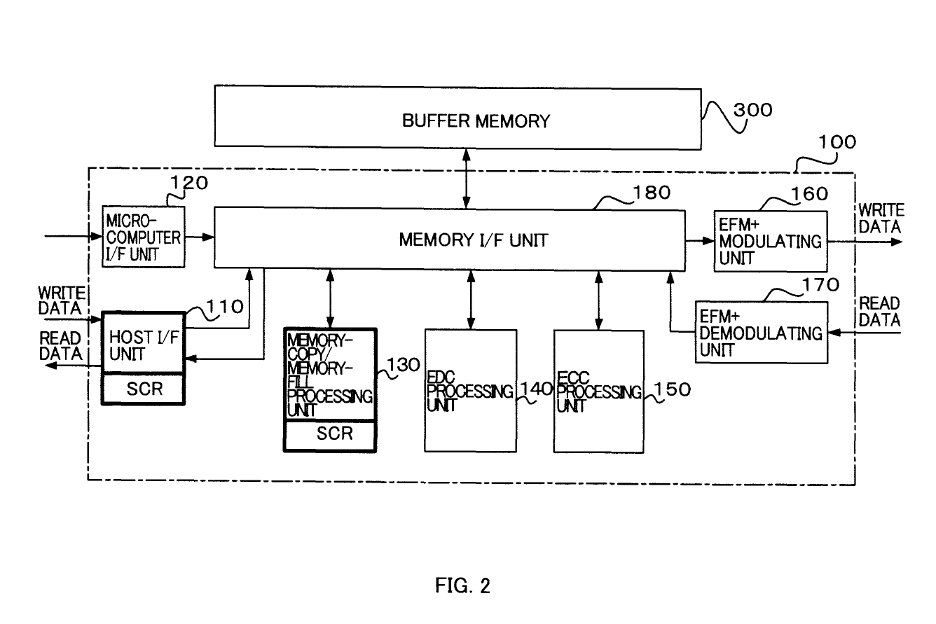

FIG. 2 is a diagram of a configuration of the digital signal processing circuit 100 according to one embodiment of the present invention.

A host I/F unit (host interface) 110 is one embodiment of an “external device interface unit” according to the present invention. That is, the host I/F unit 110 is an interface that controls data transmission/reception between the digital signal processing circuit 100 and the host computer 600. For example, ATAPI (Advanced Technology Attachment Packet Interface) can be employed.

The host I/F unit 110 includes a function of executing the scramble process or descramble process concurrently with the data transmission/reception. This is performed in order that the number of accesses to the buffer memory 300 can be reduced to shorten the total time required for the recording/reproducing process by executing the scramble process or descramble process, for which a long time is considered to be required, concurrently with the data transmission/reception.

For example, when receiving write data from the host computer 600, the host I/F unit 110 applies the scramble process to the write data and thereafter transfers the processed write data to a memory I/F (memory interface unit) 180. As a result, the write data received from the host computer 600 are subjected to the scramble process, and are thereafter divided into a plurality of pieces of 2048-byte data (main data), and the pieces of the data are written into the buffer memory 300. The host I/F unit 110 also applies the descramble process to the read data read from the buffer memory 300 through the memory I/F unit 180, and concurrently transmits the descrambled read data to the host computer 600.

A microcomputer I/F unit (microcomputer interface unit) 120 is an interface that controls data transfer between the digital signal processing circuit 100 and the microcomputer 500. For example, a three-wire serial interface, etc., can be employed.

A memory-copy/memory-fill processing unit 130 applies the scramble process or descramble process to the disc management data stored in advance in a first storage area of the buffer memory 300, and concurrently copies the scrambled or descrambled disc management data to a different area of the buffer memory 300 through the memory I/F unit 180. This copy operation is referred to as “memory copy” in the present invention. The memory copy performed concurrently with the scramble process is referred to as “scramble memory copy” and the memory copy performed concurrently with the descramble process is referred to as “descramble memory copy”.

To support the DVD-RAM standard, the memory-copy/memory-fill processing unit 130 applies the scramble process to the standard data transferred to the host computer 600 in the case of reading a non-recording area (the data entirely configured with zeros), and concurrently writes the scrambled standard data to a predetermined area of the buffer memory 300 through the memory I/F unit 180 (zero-padding). This copy operation is referred to as “memory fill” in the present invention.

An EDC processing unit 140 executes an error detection code generating process of generating and adding 4-byte EDC to the write data read from the buffer memory 300 and then writing the data into the buffer memory 300 again. The EDC processing unit 140 also applies an error detection process to the read data read from the buffer memory 300, where the error detection process is a process of detecting an error with using the EDC added to the read data. For example, a parity bit, CRC (Cyclic Redundancy Code), etc., can be employed for the EDC.

An ECC processing unit 150 executes an error correction code generating process of generating and adding the outer code parity PO and the inner code parity PI to the write data read from the buffer memory 300 through the memory I/F unit 180. The ECC processing unit 150 applies an error correction process to the read data read from the buffer memory 300 through the memory I/F unit 180. For example, a reed-solomon code, etc., can be employed for the outer code parity PO and the inner code parity PI.

An EFM+ modulating unit 160 is one embodiment of a “write data output unit” according to the present invention. That is, the EFM+ modulating unit 160 applies an interleave process, the EFM+ modulating process, and an NRZI modulating process to the write data encoded into the 1ECC block in the buffer memory 300. The write data modulated by the EFM+ modulating unit 160 are output to the analog signal processing circuit 200 and then are recorded onto the optical disc 700 by the optical pickup 400.

An EFM+ demodulating unit 170 is one embodiment of a “read data input unit” according to the present invention. That is, the EFM+ demodulating unit 170 inputs from the analog signal processing circuit 200 the read data (EFM+ signal acquired by binarizing RF signals) read from the optical disc 700 by the optical pickup 400 and performs the NRZI demodulating process, the EFM+ demodulating process, and the de-interleave process. The read data demodulated by the EFM+ demodulating unit 170 are written into the buffer memory 300 through the memory I/F unit 180.

The memory I/F unit (memory interface unit) 180 is an interface that controls the writing into and reading from the buffer memory 300.

<Configuration of Memory-Copy/Memory-Fill Processing Unit>

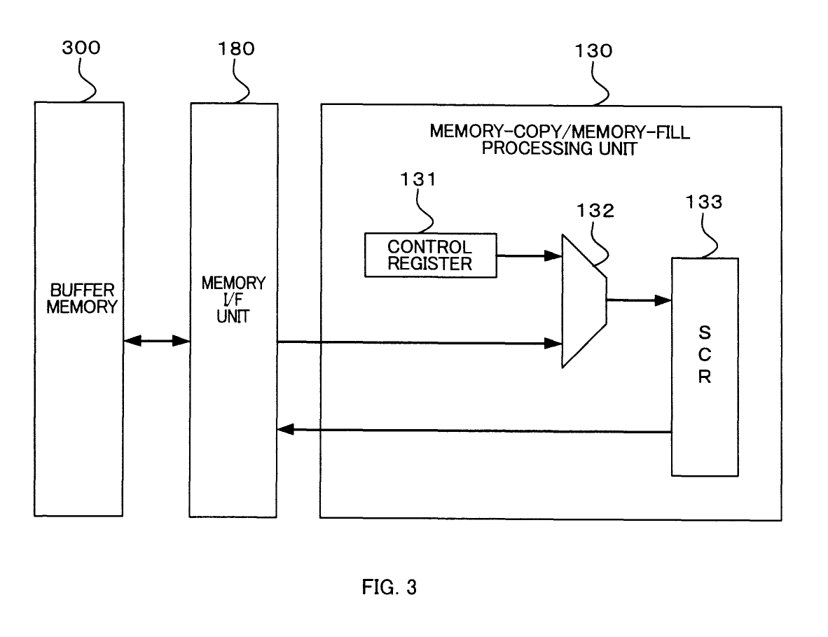

FIG. 3 is a diagram of a configuration of the memory-copy/memory-fill processing unit 130 according to one embodiment of the present invention.

A control register 131 is accessible from the microcomputer 500 and stores the standard data for the memory fill.

A multiplexer 132 selects the standard data stored in the control register 131 or the write data or the read data read from the buffer memory 300 through the memory I/F unit 180.

If the write data (disc management data) read from the memory I/F unit 180 are selected in the multiplexer 132, a scramble processing unit 133 applies the scramble process to the write data. The scrambled write data are written into the buffer memory 300 through the memory I/F unit 180. As a result, the scramble memory copy is completed.

If the read data (disc management data) read from the memory I/F unit 180 are selected in the multiplexer 132, the scramble processing unit 133 applies the descramble process to the read data. The descrambled read data are written into the buffer memory 300 through the memory I/F unit 180. As a result, the descramble memory copy is completed.

If the standard data read from the control register 131 are selected in the multiplexer 132, the scramble processing unit 133 applies the scramble process to the standard data. The scrambled standard data are written into the buffer memory 300 through the memory I/F unit 180. As a result, the memory fill is completed.

<Operation of Scramble Memory Copy>

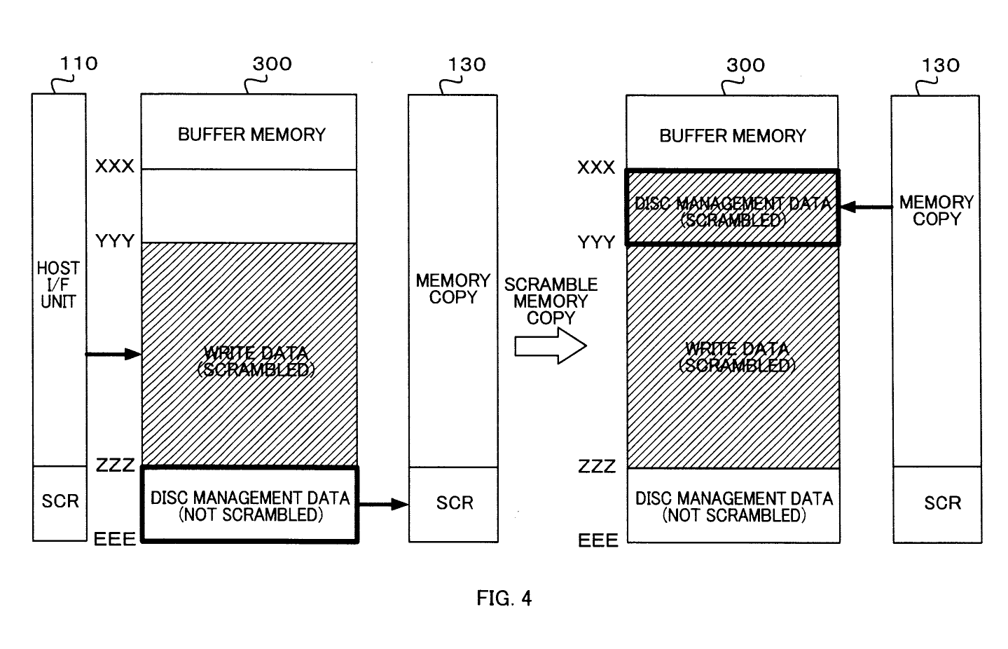

The operation of the scramble memory copy will be described with reference to FIGS. 4 and 5. In the case of an example shown in FIG. 4, when the disc management data (not scrambled) stored in the buffer memory 300 are recorded in the lead-in area 700a and the lead-out area 700b of the optical disc 700, the disc management data are scrambled, and the scrambled disc management data are concurrently copied to another area in the buffer memory 300.

The first storage area (addresses ZZZ to EEE) of the buffer memory 300 stores the disc management data managed by the microcomputer 500. In this condition, the host I/F unit 110 receives from the host computer 600 the write data to be written into the data area 700c of the optical disc 700. At this time, the host I/F unit 110 applies the scramble process to the write data received from the host computer 600, and concurrently writes the scrambled write data into a third storage area (addresses YYY to ZZZ) of the buffer memory 300.

On the other hand, the memory-copy/memory-fill processing unit 130 reads the disc management data from the first storage area (addresses ZZZ to EEE) of the buffer memory 300 through the memory I/F unit 180 independently of the scramble process for the write data in the host I/F unit 110 (see FIG. 5). The memory-copy/memory-fill processing unit 130 applies the scramble process to the read disc management data, and concurrently writes the scrambled disc management data into the second storage area (addresses XXX to YYY) of the buffer memory 300.

As a result, the buffer memory 300 stores the scrambled write data in the third storage area (addresses YYY to ZZZ) and the scrambled disc management data in the second storage area (addresses XXX to YYY). Therefore, the subsequent common recording processes (such as the error correction code generating process and the error detection code generating process) can be applied to each of the scrambled disc management data and the scrambled write data, without any inconvenience.

That is, the host I/F unit 110 executes the scramble process concurrently with reception of the write data to realize shortening the time required for the recording process (see FIG. 5), and there is circumvented the need to establish the arrangements for the recording processes (such as the error correction code generating process and the error detection code generating process) after the scramble process, for the write data received from the host computer 600, and for the disc management data managed by the microcomputer 500, separately.

<Operation of Descramble Memory Copy>

The operation of the descramble memory copy will be described with reference to FIGS. 6 and 7. In the case of an example shown in FIG. 6, when the scrambled disc management data are read from the lead-in area 700a and the lead-out area 700b of the optical disc 700 and is stored in the buffer memory 300, the disc management data are descrambled, and the descrambled disc management data are concurrently copied to another area in the buffer memory 300. Subsequently, the scrambled read data read from the user data area 700c of the optical disc 700 are written into the third storage area (addresses YYY to ZZZ) of the buffer memory 300. Thereafter, the read data written into the third storage area (addresses YYY to ZZZ) of the buffer memory 300 are subjected to the error correction process, the error detection process, etc., then are transferred to the host I/F unit 100, and are subjected to the descramble process, and the descrambled read data are concurrently transmitted to the host computer 600. On the other hand, the scrambled disc management data read from the lead-in area 700a and the scrambled disc management data read from the lead-out area 700b of the optical disc 700 are written into the second storage area (addresses XXX to YYY) of the buffer memory 300. The microcomputer 500 needs to check the disc management data stored in the second storage area (addresses XXX to YYY) of the buffer memory 300 to determine the type of the optical disc 700, etc., however, in this condition, it is difficult to check the disc management data which are scrambled.

The memory-copy/memory-fill processing unit 130 reads the scrambled disc management data from the second storage area (addresses XXX to YYY) of the buffer memory 300 through the memory I/F unit 180, independently of the scramble process for the read data in the host I/F unit 110 (see FIG. 7). The memory-copy/memory-fill processing unit 130 applies the descramble process to the read disc management data, and concurrently writes the descrambled read disc management data into the first storage area (addresses ZZZ to EEE) of the buffer memory 300.

As a result, the microcomputer 500 can appropriately access the first storage area (addresses ZZZ to EEE) of the buffer memory 300 having the descrambled disc management data stored therein to easily check the contents of the disc management data read from the optical disc 700 and can control the disc determination, etc., without any inconvenience. That is, the host I/F unit 110 executes the descramble process concurrently with transmission of the read data, and thereby the shortening of the time required for the reproducing process (see FIG. 7) can be realized and also the system control of the microcomputer 500 can be performed without any trouble.

<Operation of Memory Fill>

The operation of the memory fill will be described with reference to FIG. 8. In the case of an example shown in FIG. 8, when the non-recording area of the DVD-RAM optical disc 700 is read, the standard data (not scrambled) stored in the control register 131 are scrambled, and the scrambled standard data are concurrently written into an area in the buffer memory 300. Whether the non-recording area of the optical disc 700 is read can be detected from an arrangement of bits of the binarized signal of the RF signal, for example.

The read data read from the non-recording area of the user data area 700c of the optical disc 700 are written into the third storage area (addresses YYY to ZZZ) of the buffer memory 300. The memory-copy/memory-fill processing unit 130 reads the standard data stored in the control register 131, and applies the scramble process to the standard data, and concurrently overwrites with the scrambled standard data the read data of the non-recording area of the buffer memory 300.

As a result, since the standard data overwritten in the third storage area (addresses YYY to ZZZ) of the buffer memory 300 are scrambled, the standard data are transferred to the host I/F unit 100. The standard data are subjected to the descramble process and the descrambled standard data are concurrently transmitted to the host computer 600. The host I/F unit 110 executes the descramble process concurrently with transmission of the read data, and thereby the shortening of the time required for the reproducing process can be realized and also the data indicating the non-recording area can be transmitted to the host computer 600 without any inconvenience.

The above embodiments of the present invention are simply for facilitating the understanding of the present invention and are not in any way to be construed as limiting the present invention. The present invention may variously be changed or altered without departing from its spirit and encompass equivalents thereof.

In an embodiment according to the present invention, there has been specifically described the case that the memory-copy/memory-fill processing unit 130 applies the scramble or descramble process to the disc management data on the optical disc, and the case that the memory-copy/memory-fill processing unit 130 applies the scramble process to the standard data corresponding to the non-recording area of DVD-RAM. However, the scope of application of the present invention is not limited to this. The scramble or descramble process can be applied to any data recorded or reproduced without intervention of the host I/F unit 100 with using the memory-copy/memory-fill processing unit 130 according to an embodiment of the present invention.

In an embodiment according to the present invention, there has been described the case of the disc format for a DVD medium such as DVD±R/RW and DVD-RAM. However, the scope of application of the present invention is not limited to this. For example, the present invention is applicable to any optical disc medium corresponding to the disc format for a DVD medium, such as HD-DVD.

What is claimed is:

1. An optical disc signal processing circuit comprising:
a read data input unit configured to write read data into a buffer memory, the read data being read from an optical disc and subjected to a scramble process;
an error correction processing unit configured
to apply an error correction process to the read data read from the buffer memory, the error correction process being a process of performing error correction with an error correction code, and
to write into the buffer memory the read data subjected to the error correction process;
an external device interface unit configured
to read from the buffer memory the read data subjected to the error correction process and apply a descramble process thereto, and
to transmit to an external device the read data subjected to the descramble process; and
a memory copy processing unit configured
to read from the buffer memory the read data and apply the descramble process thereto, and
to write into the buffer memory the read data subjected to the descramble process.

2. The optical disc signal processing circuit of claim 1, wherein
the read data include user data to be transmitted to the external device and disc management data including management information on the optical disc, and wherein
the external device interface unit is configured
to read from the buffer memory the user data subjected to the error correction process and apply the descramble process thereto, and
to transmit to the external device the user data subjected to the descramble process, and wherein
the memory copy processing unit is configured
to read from the buffer memory the disc management data and apply the descramble process thereto, and
to write into the buffer memory the disc management data subjected to the descramble process.

3. The optical disc signal processing circuit of claim 1, wherein
the memory copy processing unit includes a control register configured to store predetermined standard data, and is configured
to read from the control register the standard data and apply the scramble process thereto, and
to write into the buffer memory the standard data subjected to the scramble process, and wherein
the external device interface unit is configured
to read from the buffer memory the standard data subjected to the scramble process and apply the descramble process thereto, and
to transmit to the external device the standard data subjected to the descramble process.

4. An optical disc signal processing circuit comprising:
an external device interface unit configured
to apply a scramble process to write data transmitted from an external device, and
to write into a buffer memory the write data subjected to the scramble process;
an error correction processing unit configured
to apply an error correction code generating process to the write data read from the buffer memory, the error correction code generating process being a process of generating and adding an error correction code, and
to write into the buffer memory the write data added with the error correction code;
a write data output unit configured
to read from the buffer memory the write data added with the error correction code, and
to output the write data as data to be written into the optical disc; and
a memory copy processing unit configured
to read the write data stored in the buffer memory and apply the scramble process thereto, and
to write into the buffer memory the write data subjected to the scramble process.

5. The optical disc signal processing circuit of claim 4, wherein
the write data include user data transmitted from the external device and disc management data including management information on the optical disc, and wherein
the external device interface unit is configured
to apply a scramble process to the user data transmitted from the external device, and
to transmit to the external device the user data subjected to a descramble process, and wherein
the memory copy processing unit is configured
to read from the buffer memory the disc management data and apply the scramble process thereto, and
to write into the buffer memory the disc management data subjected to the scramble process.
